(19) United States
(12) Patent Application Publication
(10) Pub. No.: US 2003/0104226 A1
(43) Pub. Date: Jun. 5, 2003

(54) Air bag-forming silicone rubber composition and silicone rubber-coated fabric

(76) Inventors: Atsushi Yaginuma, Gunma-ken (JP); Masayuki Yoshida, Gunma-ken (JP); Tsutomu Nakamura, Gunma-ken (JP)

Correspondence Address: BIRCH STEWART KOLASCH & BIRCH, PO BOX 747, FALLS CHURCH, VA, 22040-0747, US

(21) Appl. No.: 10/279,113

(22) Filed: Oct. 24, 2002

(30) Foreign Application Priority Data
Oct. 26, 2001 (JP) 2001-329243

(51) Int. Cl. B32B 9/04

(52) U.S. Cl. 428/447

(57) ABSTRACT

A silicone rubber composition comprising (A) an organopolysiloxane, (B) finely divided silica having a specific surface area of at least 50 m²/g, and (C) a benzoyl peroxide cures to base fabric through HAV at a high rate to form a safe, hygienic silicone rubber-coated fabric suitable for forming air bags.

This invention relates to air bag-forming silicone rubber compositions of the organic peroxide curing type having safety and hygienic properties and capable of coating air bag base fabrics with silicone rubber through continuous HAV, and air bag-forming silicone rubber-coated fabrics using the same.

### BACKGROUND OF THE INVENTION

Silicone rubbers have been widely used in a variety of applications on account of their excellent properties including heat resistance, freeze resistance, electrical insulation, flame retardance and compression set. For their processing, any of various well-known techniques is employed in accordance with a particular application.

The method of vulcanizing silicone rubber coating compositions may be selected from various well-known methods depending on the type of silicone rubber and the physical properties required for the cured silicone rubber. The vulcanizing method most commonly used is heat treatment in the presence of organic peroxides. Exemplary organic peroxides used are benzoyl peroxide, bis(p-chlorobenzoyl) peroxide, bis(2,4-dichlorobenzoyl) peroxide, dicumyl peroxide, di-t-butyl peroxide, 2,5-dimethyl-2,5-di(t-butylperoxy)hexane, t-butyl-perbenzoate, t-butylcumyl peroxide, etc. Of these, halogen-bearing peroxides, typically bis(2,4-dichlorobenzoyl) peroxide are often used as the vulcanizing agent which enables atmospheric pressure hot air vulcanization (HAV) to produce silicone rubber coatings with good properties at a reasonable cost.

However, the use of halogen-bearing organic peroxides gives rise to the problems that after curing, decomposed products of peroxides are left in the molded rubber which will bleed to the surface with the passage of time, and that long post-curing is necessary on account of their poison.

To avoid these problems, another coating method was proposed that relies on hydrosilylation reaction using platinum group compound catalysts whereby silicone rubber is cured by addition crosslinking reaction. However, the addition crosslinking reaction is accompanied by the problems that a pot-life must be set for working at the expense of vulcanization rate and hence, working efficiency and that a certain synthetic fiber base fabric to be coated can poison the catalyst to substantially retard reactivity.

### SUMMARY OF THE INVENTION

An object of the present invention is to provide air bag-forming silicone rubber compositions using organic peroxides which are not negatively affected by any type of synthetic fiber base fabric to be coated therewith and which when decomposed, yield no halogen-bearing compounds; and air bag-forming silicone rubber-coated fabrics using the same.

The inventor has found that organic peroxides of the general formulae (2) and (3) shown below, when compounded in silicone rubber compositions, give rise to no environmental problem due to the absence of halogen, offer a high vulcanization rate and hence, a high production efficiency, perform well under HAV conditions, and help produce silicone rubber having excellent physical properties. Air bag-forming silicone rubber-coated fabrics using such silicone rubber compositions have good adherence or integrity.

According to the invention, there is provided an air bag-forming silicone rubber composition comprising

(A) 100 parts by weight of an organopolysiloxane having the following average compositional formula (1):

R¹ₐSiO_{(4-a)/2} (1)

wherein R¹ is each independently a substituted or unsubstituted monovalent hydrocarbon group and “a” is a positive number from 1.95 to 2.04,

(B) 5 to 100 parts by weight of finely divided silica having a specific surface area of at least 50 m²/g, and

(C) 0.1 to 10 parts by weight of at least one organic peroxide selected from organic peroxides of the following general formulae (2) and (3).

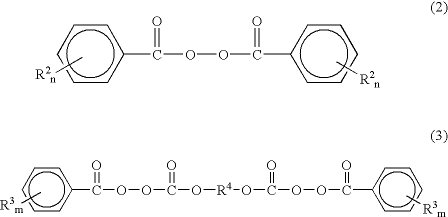

Herein R² is each independently hydrogen or an unsubstituted monovalent hydrocarbon group and n is an integer of 1 to 3; R³ is each independently hydrogen or an unsubstituted monovalent hydrocarbon group, R⁴ is an alkylene group, and m is an integer of 1 to 3.

An air bag-forming silicone rubber-coated fabric is obtained by coating a synthetic fiber base fabric with the silicone rubber composition, followed by curing and falls within the scope of the invention.

### DESCRIPTION OF THE PREFERRED EMBODIMENTS

In the air bag-forming silicone rubber composition of the invention, component (A) is an organopolysiloxane having the following average compositional formula (1):

R¹ₐSiO_{(4-a)/2} ( 1)

wherein R¹ is each independently a substituted or unsubstituted monovalent hydrocarbon group and “a” is a positive number from 1.95 to 2.04.

R¹ is independently selected from substituted or unsubstituted monovalent hydrocarbon groups, preferably having 1 to 12 carbon atoms, more preferably 1 to 8 carbon atoms, for example, alkyl groups such as methyl, ethyl, propyl, butyl, hexyl and dodecyl, cycloalkyl groups such as cyclohexyl, alkenyl groups such as vinyl, allyl, butenyl and hexenyl, aryl groups such as phenyl and tolyl, aralkyl groups such as β-phenylpropyl, and substituted ones of the foregoing groups in which some or all of the hydrogen atoms attached to carbon atoms are substituted with halogen atoms, cyano groups or the like, such as chloromethyl, trifluoropropyl and cyanoethyl. The subscript “a” is a positive number from 1.95 to 2.04.

Preferably, the organopolysiloxanes are end-blocked with trimethylsilyl, dimethylvinyl, dimethylhydroxysilyl, trivinylsilyl and other groups. It is also preferred that the organopolysiloxanes contain at least two alkenyl groups per molecule. Specifically, an alkenyl content in R¹ is preferably 0.001 to 5 mol %, more preferably 0.01 to 0.5 mol %. Vinyl is a typical alkenyl.

The organopolysiloxane can generally be produced by co-hydrolytic condensation of one or more selected organohalogenosilanes or ring-opening polymerization of a cyclic polysiloxane (siloxane trimer or tetramer or the like) in the presence of a basic or acidic catalyst. The organopolysiloxane thus obtained is generally a linear diorganopolysiloxane, but may be partially branched. A mixture of two or more different molecular structures is also acceptable.

The organopolysiloxane preferably has a viscosity of at least about 100 centistokes (cSt) at 25° C., more preferably about 100,000 to 100,000,000 cSt at 25° C., and most preferably about 5,000,000 to 20,000,000 cSt at 25° C. The degree of polymerization is preferably at least 100, especially at least 3,000, while its upper limit is preferably 100,000, especially 20,000.

Component (B) is a finely divided silica having a specific surface area of at least 50 m²/g. Component (B) is essential for obtaining silicon rubber having mechanical strength. To this end, the specific surface area should be at least 50 m²/g and preferably 100 to 400 m²/g. Examples of finely divided silica include fumed silica (or dry silica) and precipitated silica (or wet silica), with the fumed silica being preferred. For hydrophobizing, silica may have been surface treated with organopolysiloxanes, organopolysilazanes, chlorosilanes, alkoxysilanes or the like. Such silicas may be used alone or in admixture.

Finely divided silica is added in an amount of 5 to 100 parts by weight per 100 parts by weight of the organopolysiloxane (A). Less than 5 parts of silica is insufficient to achieve reinforcement effects whereas more than 100 parts can compromise the workability of the composition and detract from the physical properties of silicone rubber. The preferred amount of silica added is 10 to 90 parts by weight, and especially 30 to 80 parts by weight.

Component (C) is an organic peroxide selected from organic peroxides of the following general formulae (2) and (3) and mixtures thereof.

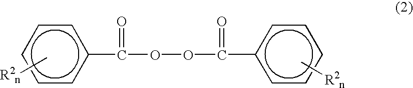

Herein R² is each independently hydrogen or an unsubstituted monovalent hydrocarbon group and n is an integer of 1 to 3.

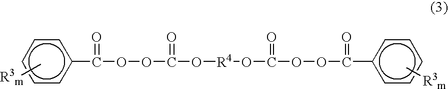

Herein R³ is each independently hydrogen or an unsubstituted monovalent hydrocarbon group, R⁴ is an alkylene group, and m is an integer of 1 to 3.

In formula (2), R² is independently selected from hydrogen and unsubstituted monovalent hydrocarbon groups. Preferably R² is selected from C₁-C₁₂ alkyl groups such as methyl, ethyl, propyl and butyl, with methyl being most preferred. The subscript n is an integer of 1 to 3.

Illustrative examples of organic peroxides having formula (2) include o-methylbenzoyl peroxide, p-methylbenzoyl peroxide, and 2,4-dimethylbenzoyl peroxide. Of these, o-methylbenzoyl peroxide and p-methylbenzoyl peroxide are especially preferred.

In formula (3), R³ is independently selected from hydrogen and unsubstituted monovalent hydrocarbon groups. Preferably R³ is selected from hydrogen and C₁-C₁₂ alkyl groups such as methyl, ethyl, propyl and butyl, with methyl being most preferred. R⁴ is selected from alkylene groups, preferably C₁-C₁₂ alkylene groups, especially C₂-C₈ alkylene groups such as methylene, ethylene, propylene, butylene and hexylene. The subscript m is an integer of 1 to 3.

Illustrative examples of organic peroxides having formula (3) include 1,6-bis(p-toluoylperoxycarbonyloxy)hexane of the following formula (4), 1,6-bis(benzoylperoxy-carbonyloxy)hexane of the following formula (5), 1,6-bis(p-toluoylperoxycarbonyloxy)butane, and 1,6-bis(2,4-dimethylbenzoylperoxycarbonyloxy)hexane.

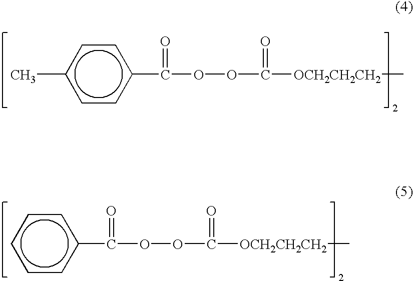

Of these, 1,6-bis(p-toluoylperoxycarbonyloxy)hexane of formula (4) and 1,6-bis(benzoylperoxycarbonyloxy)hexane of formula (5) are preferred.

In order that the organic peroxide (C) be intimately and safely mixed with a silicone rubber compound composed mainly of components (A) and (B), component (C) is preferably mixed with a suitable inert carrier, preferably a silicone fluid compatible with the rubber compound such as polydimethylsiloxane of formula (1), or organopolysiloxane gum (raw rubber), and optionally, an inorganic filler such as silica to form a paste, prior to use. The preferred content of component (C) in the paste is 20 to 90% by weight, more preferably 30 to 80% by weight.

The organic peroxide (C) is added in an amount of 0.1 to 10 parts by weight, preferably 0.2 to 5 parts by weight, per 100 parts by weight of the organopolysiloxane (A). Less than 0.1 part of the organic peroxide leads to under-crosslinking whereas more than 10 parts of the organic peroxide provides no further improvement in curing rate and leaves more unreacted and decomposed residues which need a time-consuming removal.

The silicone rubber composition of the invention may preferably include an adhesion promoter for the purpose of improving adhesion to synthetic fiber base fabric. Suitable adhesion promoters include silane coupling agents and partial hydrolyzates thereof, and reaction products of different silane coupling agents. Preferred adhesion promoters are epoxy functional silanes and partial hydrolyzates thereof, for example, those of the following general formula (6):

R⁵ₚSi (OR⁶)₄₋ₚ (6)

wherein R⁵ is a monovalent organic group having an epoxy group, R⁶ is each independently hydrogen or an unsubstituted monovalent hydrocarbon group, and p is an integer of 1 to 3, and partial hydrolyzates thereof.

In formula (6), R⁵ is typically a group of the following formula (7).

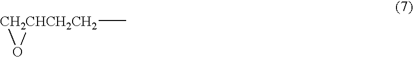

R⁶ is independently selected from hydrogen and unsubstituted monovalent hydrocarbon groups, preferably C₁-C₁₂ alkyl groups such as methyl, ethyl, propyl and butyl. The subscript p is an integer of 1 to 3.

Illustrative examples of the compound of formula (6) include γ-glycidoxypropyltrimethoxysilane and β-(3,4-epoxycyclohexyl)ethyltrimethoxysilane. Reaction products of these silane coupling agents with other silane coupling agents such as amino functional silanes are also useful. Besides, organosilanes having an isocyanate group and a hydrolyzable group in a molecule and (partial) hydrolyzates thereof may also be used for improving adhesion.

The adhesion promoter is preferably blended in an amount of 0.1 to 20 parts by weight, more preferably 0.5 to 10 parts by weight per 100 parts by weight of the organopolysiloxane (A).

If necessary, in addition to the above-mentioned components, the silicone rubber composition of the invention includes various additives such as wetters, heat resistance modifiers, inorganic fillers, flame retardants, pigments, electrically conductive agents, acid acceptors, and dispersants (e.g., silanol group-bearing low molecular weight siloxanes) as long as they do not interfere with the objects of the invention.

Suitable wetters include low molecular weight organosilicon compounds such as hydroxyl-terminated diorganopolysiloxanes, diphenylsilane diols, hexaorganopolysiloxanes, and organoalkoxysilanes. Suitable heat resistance modifiers include metal oxides such as iron oxide, cerium oxide, zinc oxide, and titanium oxide, cerium silanolate, and cerium salts of fatty acids. Suitable inorganic fillers include diatomaceous earth, quart flour, calcium carbonate, and carbon black. Useful flame retardants include microparticulate platinum adsorbed on such carriers as silica, alumina or silica gel, platinum compounds such as platinum chloride, chloroplatinic acid, complexes of chloroplatinic acid hexahydrate with olefins or divinyldimethylpolysiloxane, and alcohol solutions of chloroplatinic acid hexahydrate, titanium oxide, and nitrogen-containing organic compounds. Besides, compounds having at least two silicon-bonded hydrogen atoms per molecule or the like may also be added which are effective for promoting vulcanization and improving adhesion.

To the silicone rubber composition of the invention, an organic solvent is preferably added. Useful organic solvents are those in which component (A) is dissolvable, for example, xylene, toluene, benzene, hexane, heptane, rubber solvent, hexamethyldisiloxane and octamethylcyclo-tetrasiloxane. Toluene is the preferred organic solvent. The organic solvents may be used alone or in admixture.

In the practice of the invention, the silicone rubber composition containing components (A), (B) and (C) is preferably dissolved in an organic solvent to form a solution prior to coating. The amount of the organic solvent used herein is preferably adjusted such that the concentration of the silicone rubber composition is 5 to 80% by weight, more preferably 10 to 60% by weight, most preferably 20 to 40% by weight.

The silicone rubber composition of the invention is generally prepared by intimately mixing components (A) and (B) in a rubber milling machine such as a two-roll mill, Banbury mixer or dough mixer (kneader), adding component (C) and optionally, an organic solvent, and continuing milling.

With respect to the conditions under which the silicone rubber composition is vulcanized, any desired technique may be used as long as it applies a sufficient heat to incur decomposition of the curing agent. The molding method is not critical and may be extrusion molding combined with continuous atmospheric pressure hot air vulcanization (HAV), press vulcanization or injection vulcanization. HAV is preferred in the practice of the invention. Preferred conditions for HAV include a heating temperature of about 80 to 400° C., more preferably about 100 to 300° C., most preferably about 120 to 200° C. and a heating time of about 5 seconds to 1 hour, more preferably about 30 seconds to 30 minutes, most preferably about 1 to 20 minutes. If necessary, this may be followed by secondary vulcanization at about 120 to 220° C. for about 30 minutes to about 10 hours.

Examples of the synthetic fiber base fabric (air bag-forming base fabric) used herein include fabrics composed of polyamide fibers such as nylon 6, nylon 66 and nylon 46, aramid fibers such as copolymers of p-phenylene terephthalamide with all aromatic ether, polyester fibers such as polyalkylene terephthalate, polyvinyl alcohol fibers, rayon fibers, polyolefin fibers, polyether imide fibers, and carbon fibers. The method of applying the silicone rubber composition to such base fabric may be any well-known coating method. The thickness of the coating may be determined as appropriate. The coating weight of the silicone rubber composition is preferably 5 to 300 g/m², especially 20 to 150 g/m².

### EXAMPLE

Examples of the invention are given below by way of illustration and not by way of limitation. In Examples, all parts are by weight.

### Example 1

In a kneader, 100 parts of an organopolysiloxane consisting of 99.850 mol % dimethylsiloxane units, 0.125 mol % methylvinylsiloxane units and 0.025 mol % dimethylvinylsiloxane units and having an average degree of polymerization of about 8,000 was milled with 40 parts of fumed silica having a specific surface area of 200 m²/g (Aerosil 200, Nippon Aerosil Co., Ltd.) and 10 parts of dimethylpolysiloxane blocked with a silanol group at either end, having an average degree of polymerization of 13 and a viscosity of 15 cSt at 25° C. as the dispersant. The mixture was heat treated at 180° C. for 3 hours, yielding Compound 1.

With stirring at room temperature, 30 parts of Compound 1 was dissolved in 70 parts of toluene. To 100 parts of this toluene solution were added 1.0 part of a 50% silicone oil paste of 1,6-bis(p-toluoylperoxycarbonyloxy)hexane as the curing agent and 1.0 part of γ-glycidoxypropyltrimethoxysilane. This yielded silicone rubber composition 1 (Example 1).

### Example 2

With stirring at room temperature, 30 parts of Compound 1 was dissolved in 70 parts of toluene. To 100 parts of this toluene solution were added 1.0 part of a 50% silicone oil paste of p-methylbenzoyl peroxide as the curing agent and 1.0 part of γ-glycidoxypropyltrimethoxysilane. This yielded silicone rubber composition 2 (Example 2).

### Example 3

With stirring at room temperature, 30 parts of Compound 1 was dissolved in 70 parts of toluene. To 100 parts of this toluene solution were added 1.0 part of a 50% silicone oil paste of o-methylbenzoyl peroxide as the curing agent and 1.0 part of γ-glycidoxypropyltrimethoxysilane. This yielded silicone rubber composition 3 (Example 3).

### Example 4

With stirring at room temperature, 30 parts of Compound 1 was dissolved in 70 parts of hexamethyldisiloxane. To 100 parts of this solution were added 1.0 part of a 50% silicone oil paste of p-methylbenzoyl peroxide as the curing agent and 1.0 part of γ-glycidoxypropyltrimethoxysilane. This yielded silicone rubber composition 4 (Example 4).

### Comparative Example 1

With stirring at room temperature, 30 parts of Compound 1 was dissolved in 70 parts of toluene. To 100 parts of this toluene solution were added 1.0 part of a 50% silicone oil paste of 2,4-dichlorobenzoyl peroxide as the curing agent and 1.0 part of γ-glycidoxypropyltrimethoxysilane. This yielded silicone rubber composition 5 (Comparative Example 1).

### Comparative Example 2

With stirring at room temperature, 30 parts of Compound 1 was dissolved in 70 parts of toluene. To 100 parts of this toluene solution were added 0.2 part of a polyvinylsiloxane complex of a platinum compound as the curing agent, 0.02 part of 1-ethynylcyclohexan-1-ol, 0.5 part of a both end trimethylsiloxy group-blocked dimethylsiloxane/methylhydrogensiloxane copolymer (Si—H 0.007 mol/g), and 1.0 part of γ-glycidoxypropyltrimethoxysilane. This yielded silicone rubber composition 6 (Comparative Example 2).

Woven fabrics of nylon 66 fibers (420 denier) were uniformly coated with the silicone rubber compositions 1 to 6 prepared above so as to give a coating weight (solids) of 50 g/m². They were air dried at room temperature for 15 minutes and vulcanized at 100° C. for 1 minute, then at 180° C. for 3 minutes. The coated fabrics thus obtained were allowed to stand for 24 hours and inspected for outer appearance, i.e., whether or not blooming occurred. Adhesion was rated by a Scott flexing test (2 kgf, 500 strokes). The results are shown in Table 1.

TABLE 1

| | Example | | | | Comparative Example | |
|---|---|---|---|---|---|---|
| | 1 | 2 | 3 | 4 | 1 | 2 |
| Composition | 1 | 2 | 3 | 4 | 5 | 6 |
| Appearance | nil | nil | nil | nil | Bloomed | nil |
| (blooming) | | | | | | |
| Scott flexing | Pass | Pass | Pass | Pass | Pass | Partially |
| test | | | | | | separated |

The samples of Examples showed non-blooming properties and excellent adhesion.

The silicone rubber composition of the invention has a high vulcanization rate and cures into a safe, hygienic silicone rubber having excellent physical properties. By coating a synthetic fiber base fabric with the composition and curing the coating, a silicone rubber-coated fabric having good integral adhesion is obtained and suited for forming air bags.

Japanese Patent Application No. 2001-329243 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. An air bag-forming silicone rubber composition comprising
(A) 100 parts by weight of an organopolysiloxane having the following average compositional formula (1):
R¹ₐSiO_{(4-a)/2} (1)
wherein R¹ is each independently a substituted or unsubstituted monovalent hydrocarbon group and “a” is a positive number from 1.95 to 2.04,
(B) 5 to 100 parts by weight of finely divided silica having a specific surface area of at least 50 m²/g, and
(C) 0.1 to 10 parts by weight of at least one organic peroxide selected from organic peroxides of the following general formulae (2) and (3): 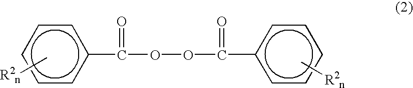
wherein R² is each independently hydrogen or an unsubstituted monovalent hydrocarbon group and n is an integer of 1 to 3, 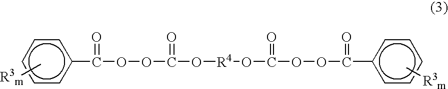
wherein R³ is each independently hydrogen or an unsubstituted monovalent hydrocarbon group, R⁴ is an alkylene group, and m is an integer of 1 to 3.

2. The silicone rubber composition of claim 1, further comprising an organic solvent.

3. The silicone rubber composition of claim 1, further comprising 0.1 to 20 parts by weight of an adhesion promoter per 100 parts by weight of the organopolysiloxane (A).

4. The silicone rubber composition of claim 1 wherein the finely divided silica (B) is fumed silica.

5. The silicone rubber composition of claim 1 wherein the organic peroxide (C) is o-methylbenzoyl peroxide and/or p-methylbenzoyl peroxide.

6. The silicone rubber composition of claim 1 wherein the organic peroxide (C) is 1,6-bis(p-toluoylperoxycarbonyloxy)hexane of the following formula (4) and/or 1,6-bis(benzoylperoxycarbonyloxy)hexane of the following formula (5)

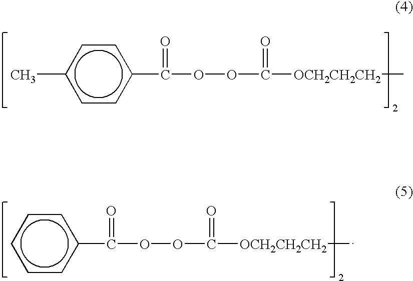

7. An air bag-forming silicone rubber-coated fabric obtained by coating a synthetic fiber base fabric with the silicone rubber composition of claim 1, followed by curing.
